(19) United States
(12) Patent Application Publication
(10) Pub. No.: US 2005/0278379 A1
(43) Pub. Date: Dec. 15, 2005

(54) Image retrieval device and image retrieval method

(75) Inventor: Kazuhiko Nakazawa, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/148,270

(22) Filed: Jun. 9, 2005

(30) Foreign Application Priority Data
Jun. 10, 2004 (JP) 2004-173012

(51) Int. Cl. G06F 7/00

(52) U.S. Cl. 707/104.1

(57) ABSTRACT

Similar image data, which are similar to a target image data to which a keyword is to be added, are retrieved. Then, keywords added to the retrieved similar image data are added to the target image data. By diverting the keywords of the similar image data, which are similar to the target image data, to keywords of the target image data, addition candidates can be limited to relatively relevant keywords, and thereby a burden in adding a keyword is reduced.

### FIELD OF THE INVENTION

This invention relates to a technique for retrieving image data and, more particularly, a technique for utilizing information added to image data.

### BACKGROUND OF THE INVENTION

Recently, image retrieval devices such as a digital still cameras have remarkably developed. More particularly, the capacity of recording media for storing image data, which are to be used in image retrieval devices, has significantly increased.

However, the increase in the capacity of storage media has made it difficult to quickly retrieve a desired image data. That is, it takes much time for an operator to find a desired image data from a storage medium in which a lot of image data are stored by displaying the image data one by one.

In order to reduce such a burden imposed on the operator, a technique of adding a keyword to each image data in advance to retrieve an image data based on the keyword will be effective. For example, the keyword “wedding” is added to an image data taken at a wedding. Then by executing a keyword search with the use of the keyword “wedding”, an image data corresponding to “wedding” is retrieved.

In order to execute such a keyword search, it is necessary to add a keyword to each image data in advance. However, in the case of equipment without a character input device like a keyboard, such as a digital still camera, it remains very cumbersome to add a keyword to each image data.

To cope with this problem, a technique of simplifying input of keywords by preparing a list including multiple keyword candidates in advance to enable an operator to select a desired keyword from the list has been proposed (Japanese Patent Laid-Open No. 2002-344721).

However, in the above technique, as the number of keyword candidates increases, a lot of irrelevant keywords are displayed together, and this makes the selection difficult.

The object of the present invention is to solve this problem and other ones. The other problems will be understood through this specification.

### SUMMARY OF THE INVENTION

According to the present invention, in order to solve the above problem, similar image data, where the data is similar to a target image data to which a keyword is to be added, are retrieved first. Then, keywords added to the retrieved similar image data are added to the target image data.

According to the present invention, since the keywords of similar image data, which are similar to a target image data, are added to the target image data, the burden of adding a keyword is reduced. Furthermore, since keyword candidates can be limited to a relatively small group of relevant keywords, the burden of adding a keyword is also reduced.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing an example of the configuration of an image retrieval device according to this embodiment;

FIG. 2 shows an example of the external configuration of the image retrieval device according to this embodiment;

FIG. 3 shows an example of the configuration of a search database according to this embodiment;

FIG. 4 is a flowchart showing an illustrative keyword addition process according to this embodiment;

FIG. 5 is a flowchart showing an illustrative keyword addition process according to this embodiment;

FIG. 6 illustrates a concept of a keyword addition process according to this embodiment;

FIG. 7 shows an example of display of illustrative keyword candidates according to this embodiment;

FIG. 8 is a flowchart showing an illustrative image data keyword retrieval process according to this embodiment;

FIG. 9 shows an illustrative keyword addition process according to this embodiment;

FIG. 10 shows an example of a screen for selecting an addition target image, according to this embodiment; and

FIG. 11 shows an example of a screen display for selecting a keyword-added image data and its keyword, according to this embodiment.

### DETAILED DESCRIPTION OF THE PREFERRED EMBODIMENTS

Preferred embodiments of the present invention will now be described in detail in accordance with the accompanying drawings.

### First Embodiment

An image retrieval device according to this embodiment will be described below. The image retrieval device according to this embodiment includes both of a device with an imaging ability, such as an imaging device, and a device without an imaging ability, such as a PDA. More specifically, the former is a digital still camera, a digital video camera, a mobile telephone with a camera, a PDA (mobile information terminal) with a camera, or a PC (personal computer) with a USB camera connected thereto, and the latter is a PDA, PC and the like without a camera function.

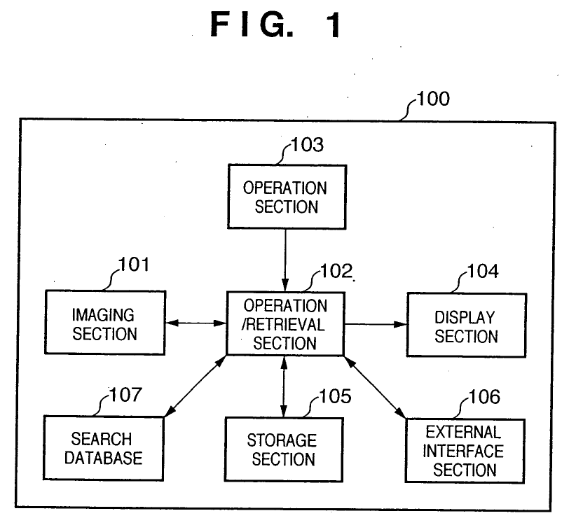

FIG. 1 is a block diagram showing an example of the configuration of an image retrieval device according to this embodiment. Reference numeral 101 denotes an imaging section for taking an image. The imaging section 101 is configured by a lens, a CCD or CMOS sensor, and the like. Reference numeral 102 denotes an operation/retrieval section for performing overall control of the image retrieval device 100, image processing and an image retrieval process. The operation/retrieval section 102 can be configured by a CPU, a ROM (including a control program) and a RAM, or an integrated circuit having functions equal to the functions of these. Reference numeral 103 denotes an operation section used by an operator to operate the image retrieval device 100. The operation section 103 is configured by a cross key, a decision/cancel button, a shutter button, an interface circuit or the like for connecting these to the operation/retrieval section 102. Reference numeral 104 denotes a display section for displaying various operation screens and a result of operation. The display section 104 is configured by a liquid crystal display device or the like. Reference numeral 105 denotes a storage section to store and read various data, such as an image, in and from. The storage section 105 is configured by a detachable recording medium, a control interface circuit for controlling reading from and writing to the recording medium, and the like. Reference numeral 106 denotes an external interface section for performing data communication with an external device such as a PC. The external interface section 106 is configured by a communication circuit in conformity with a communication method such as USB, IEEE1394, Bluetooth, wireless LAN, IrDA or Ethernet®. Reference numeral 107 denotes a search database to be referred to when search is performed. The search database 107 is stored, for example, in a non-volatile memory (an EEPROM, a RAM backed up by a battery, a hard disk drive or the like) of the image retrieval device 100. Of course, the search database 107 may be connected to the operation/retrieval section 102 via the external interface section 106, as described later.

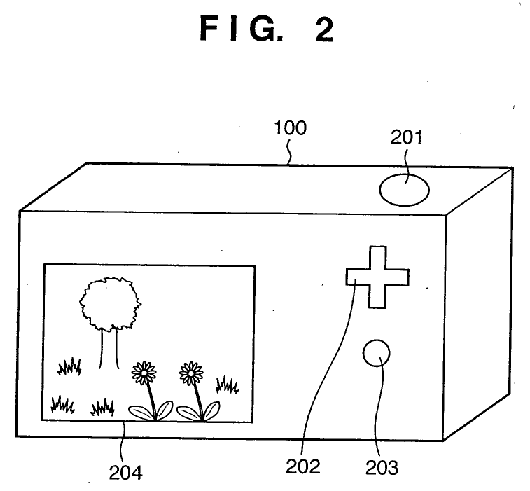

FIG. 2 shows an example of the external configuration of the image retrieval device according to this embodiment. Reference numeral 201 denotes a shutter button of the image retrieval device 100, which is a part of the above-described operation section 103. Reference numeral 202 denotes a cross key for operating the image retrieval device 100, which is a part of the above-described operation section 103. Reference numeral 203 denotes an operation button for instructing decision/cancel, which is a part of the above-described operation section 103. For example, an operator uses the cross key 202 and the operation button 203 to select a keyword. The cross key 202 and the operation button 203 may be arranged on any place on the image retrieval device 100, and the operation button 203 may be of any shape. Reference numeral 204 denotes a display screen of the image retrieval device 100 and corresponds to the above-described display section 104. When the image retrieval device 100 operates in an imaging mode, a preview image or a taken image is displayed thereon. When the image retrieval device 100 operates in a browse mode, an image data stored in a storage medium in the storage section 105 is displayed thereon. When a keyword is added, an addition target image or a list of keyword candidates is displayed thereon.

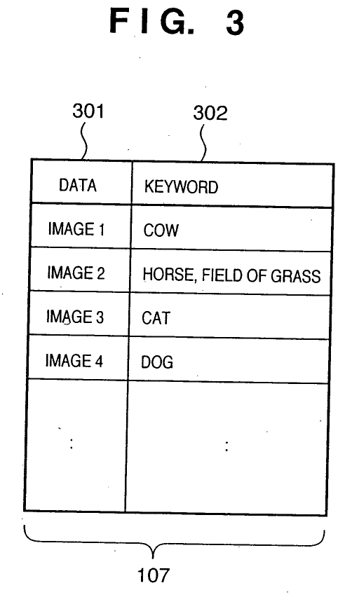

FIG. 3 shows an example of the configuration of a search database according to this embodiment. The search database 107 is adapted to store an image data and a keyword in association with each other. In a data field 301, the name of an image data (or a filename specified by a full path) is stored. In a keyword field 302, one or more keywords are stored. For example, a keyword “cow” is set for an image 1. Multiple keywords may be set for one image as set for an image 2.

A feature point of an image generated from the image, instead of the image, may be recorded in the search database 107. The feature point of the image means information which is useful when it is determined whether two image data are similar to each other. The feature point may differ when the similarity determination method differs.

By receiving a request for registration of data from an external device connected to the image retrieval device 100 via the external interface section 106, the data can be added to the search database 107. Similarly, by receiving an update request or a deletion request, a specified data can be updated or deleted. When a keyword is set for an image data by an operator, the operation/retrieval section 102 may add the image data and the keyword to the search database 107.

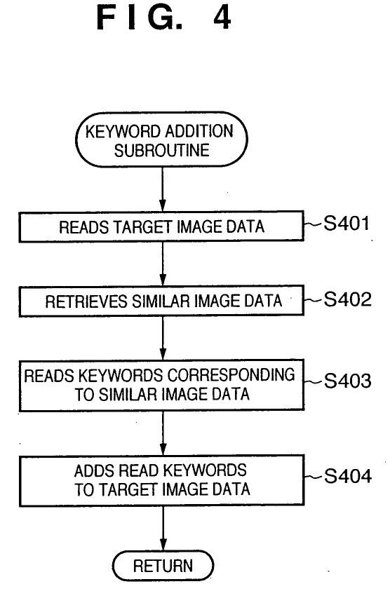

FIG. 4 is a flowchart showing an illustrative keyword addition process according to this embodiment.

At step S401, the operation/retrieval section 102 reads an addition target image data to which a keyword is to be added, from a storage medium of the storage section 105. The storage medium may be a detachable flash memory card or an internal RAM.

At step S402, the operation/retrieval section 102 retrieves similar image data from the search database 107 with the read addition target image data used as a key image data.

At step S403, the operation/retrieval section 102 reads one or more keywords corresponding to the retrieved addition target image data from the search database 107.

At step S404, the operation/retrieval section 102 adds all or a part of the read keywords as the keywords of the addition target image data.

As described above, in this embodiment, keywords of similar image data, which are similar to a target image data, are diverted to the keywords of the target image data, and thereby, a burden on an operator in adding a keyword is reduced. That is, if multiple image data are similar to one another, there is a possibility that their keywords are also similar to one another; and therefore, a burden on an operator is reduced by limiting keywords to those that are considered to be relatively relevant before making an operator select a keyword rather than displaying all arbitrary keywords to make the operator select a keyword.

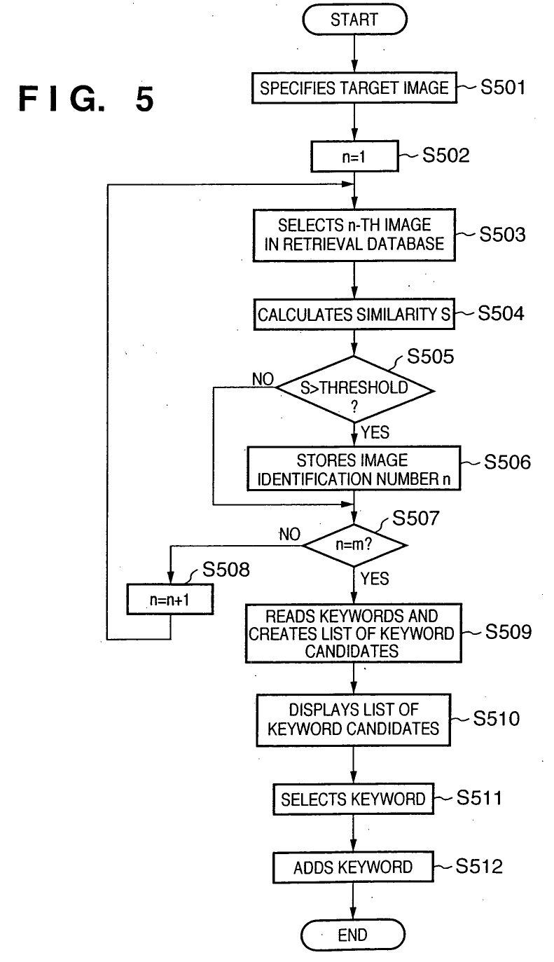

FIG. 5 is a flowchart showing an illustrative keyword addition process according to this embodiment. The flowchart shows an example of a more detailed process than that of the flowchart shown in FIG. 4.

At step S501, the operation/retrieval section 102 specifies an addition target image data in response to a specification instruction from the operation section 103. For example, by causing the display section 104 to display image data stored in a storage medium of the storage section 105, the operation/retrieval section 102 specifies an addition target image data from among the displayed image data in response to an operation instruction from the operation section. If the image retrieval device 100 is provided with the imaging section 101, the operation/retrieval section 102 may specify an image data acquired by the imaging section 101.

At step S502, the operation/retrieval section 102 initializes a variable n for counting the image identification number of images in the search database 107, to 1. It is assumed that m image data are registered with the search database 107.

At step S503, the operation/retrieval section 102 selects and reads the n-th image data.

At step S504, the operation/retrieval section 102 calculates similarity S between the addition target image data and the selected n-th image data with the use of a predetermined comparison algorithm.

The present invention is not influenced by the kind of the comparison algorithm, and any comparison algorithm may be adopted. For example, the similarity S is calculated by binarizing the density of each pixel in an image based on whether the density is above a predetermined threshold to generate a binarized image, comparing the generated binarized image with a binarized key image data, and counting the number of corresponding pixels therebetween. Alternatively, the similarity S may be calculated by adopting a method in which a histogram expressing the tone of the entire image is utilized or a method in which the outline is extracted based on the frequency component of an image. Furthermore, the similarity S may be calculated by comparing color information or information about the shape, the inclination and the like of an object. Of course, these similarity calculation methods are only examples, and the present invention may adopt other similarity calculation methods.

At step S505, the operation/retrieval section 102 determines whether the calculated similarity S exceeds a predetermined threshold. If it does, the process proceeds to step S506. Otherwise, the process proceeds to step S507. The predetermined threshold can be arbitrarily set. Generally, as the threshold is increased, the number of retrieved similar image data is decreased, and therefore the number of retrieved keywords is also decreased. As the threshold is decreased, the number of retrieved similar image data is increased, and therefore the number of retrieved keywords is also decreased. It is a designing matter to determine at which level the threshold is to be set. It is desirable to set the threshold at such a level that the number of retrieved keywords does not exceed the number suitable for selection by an operator.

At step S506, the operation/retrieval section 102 temporarily stores an image identification number n of a similar image data in a RAM and proceeds to step S507. For example, a list of similar image data is created; the image identification number is added to the list; and then the list is stored in the RAM. Information other than an image identification number, such as a file name may be used only if image data can be identified by the information.

At step S507, the operation/retrieval section 102 determines whether the retrieval process has ended for all the image data stored in the search database 107. For example, it is determined whether n and m correspond to each other. If the retrieval process has been completed, then the process proceeds to step S509. If the retrieval process has not been completed yet, the operation/retrieval section 102 adds 1 to n at step S508 and returns to step S503.

At step S509, the operation/retrieval section 102 reads keywords corresponding to the retrieved similar image data, from the search database 107. For example, the above-described list of similar image data is read from the RAM, and corresponding keywords are read based on image identification numbers registered with the list to create a list of keyword candidates.

At step S510, the operation/retrieval section 102 reads the list of keyword candidates from the RAM and causes the keyword candidates included in the list to be displayed on the display section 104.

At step S511, the operation/retrieval section 102 selects a keyword candidate selected via the operation section 103 as a keyword for the addition target image data, from among the displayed keyword candidates. Multiple keywords may be selected.

At S512, the operation/retrieval section 102 adds the selected keyword to the addition target image data. The addition method may be any method. For example, by linking the keyword to the addition target image data, the keyword and the addition target image data are stored together in a recording medium. More specifically, the operation/retrieval section 102 may create a database inside the image retrieval device 100 for storing the correspondence relation (link) between the addition target image data and the keyword. Alternatively, the operation/retrieval section 102 may write the keyword in the header portion of the addition target image data. The operation/retrieval section 102 may embed the keyword in the addition target image data itself as image information. Of course, any other method may be adopted only if the relation between the image data and the keyword can be maintained thereby.

For example, when the operation/retrieval section 102 stores the addition target image data in a recording medium, the keyword may be reflected on its filename. For example, if “flower” and “butterfly” are the keywords, then an example of the filename of the addition target image data is “flower_butterfly.jpg” or the like. Of course, the filename may be in other forms.

Furthermore, the addition target image data to which the keyword is linked may be added to the search database 107. An existing image data in the search database 107 may be replaced with the addition target image data to which the keyword is linked. Alternatively, an existing image data may be deleted from the search database 107.

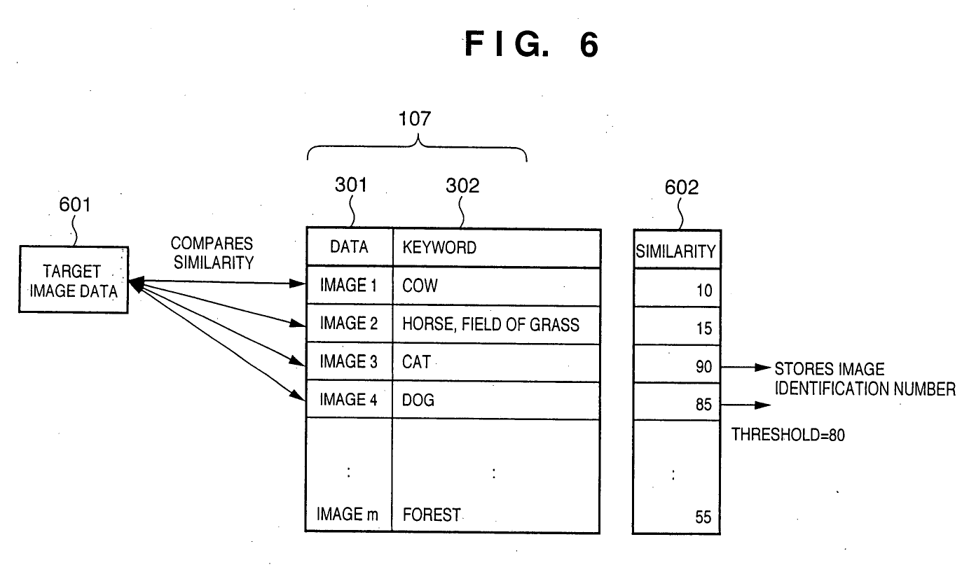

FIG. 6 illustrates a concept of a keyword addition process according to this embodiment. As shown in the figure, it is assumed that m image data are already registered with the search database 107. An addition target image data 601 is compared with the first image data (image 1) of the search database 107, and the similarity S is calculated. In this example, the similarity with the image 1 is 10. If a similarity threshold is 80, the similarity with the image 1 is lower than the threshold, and therefore the image identification number is not stored. Subsequently, the process of comparison of the addition target image data 601 with image data up to the m-th image data of the search database 107 is performed similarly. Finally, image identification numbers of image data with similarity above the predetermined value are listed and stored inside the image retrieval device 100. In this example, “3” and “4” are stored. Then, keywords added to image data corresponding to these image identification numbers are displayed on the screen as keyword candidates. In this example, the keyword candidates to be displayed are “cat” and “dog”. If the operator operates the operation section 103 to select the keyword “cat”, then the keyword “cat” is linked to the addition target image data 601 and stored.

The comparison method and the comparison order are not limited to those described in the flow described with reference to FIGS. 5 and 6.

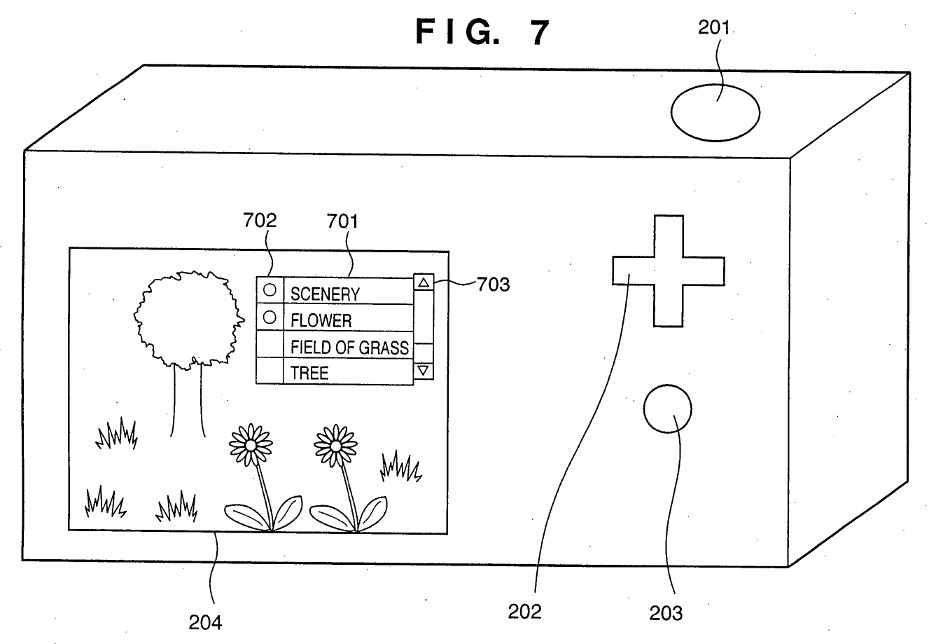

FIG. 7 shows an example of display of illustrative keyword candidates according to this embodiment. Reference numeral 701 denotes a list of keyword candidates. When there are multiple keyword candidates, the operator can select a keyword more easily if they the keyword candidates are displayed in descending order with a keyword of an image data with the highest similarity at the top.

In this example, the keyword candidates are “scenery”, “flower”, “field of grass” and “tree”. Reference numeral 702 denotes a checkbox for selecting keywords which the operator wants to add to an addition target image data. In this example, since the keywords “scenery” and “flower” are selected, these two keywords are to be added to the addition target image data. Reference numeral 703 denotes a scrollbar to be displayed when the number of keyword candidates in the list of keyword candidates 701 is above a predetermined number. Thereby, even if there are a lot of keyword candidates, they can be displayed within the display screen. The list of keyword candidates 701, the checkbox 702 and the scrollbar 703 may be translucent so that the addition target image can be seen through them. Thereby, it is possible to select a keyword while generally checking the entire addition target image data.

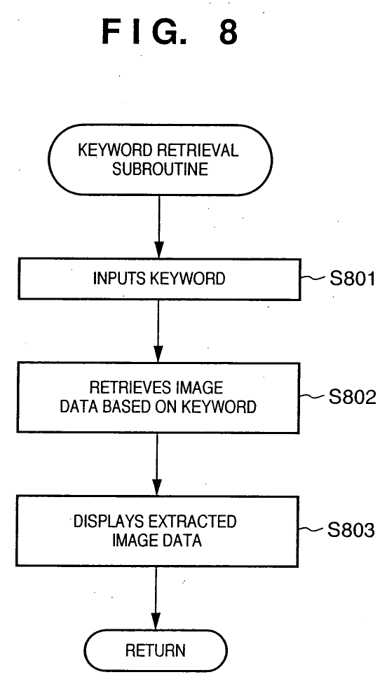

FIG. 8 is a flowchart showing an illustrative image data keyword retrieval process according to this embodiment. When an image retrieval mode is selected in response to operation of the cross key 202 or the operation button 203, the mode of the operation/retrieval section 102 is shifted to the image retrieval mode.

At step S801, the operation/retrieval section 102 inputs a keyword for image retrieval in response to operation of the cross key 202 or the operation button 203. For example, the operation/retrieval section 102 displays alphabets on the display section 104 and inputs a keyword by selecting letters from the alphabets in response to operation of the operation button 203 and the cross key 202. Alternatively, thumbnails of some image data may be displayed on the display section 104 so that keywords of images selected from among them are used.

At step S802, the operation/retrieval section 102 retrieves an image data having a keyword corresponding to or semantically similar to the inputted keyword, from among keyword-added image data.

At step S803, the operation/retrieval section 102 displays the retrieved image data on the display section 104. If there are multiple candidate images, thumbnails may be displayed, for example.

As described above, according to this embodiment, other image data similar to a target image data, for which addition of a keyword is desired, is extracted, and the keyword added to the extracted image data is diverted to the keyword of the target image data, and thereby a burden in inputting a keyword is reduced. Especially in an image retrieval device without an input device facilitating input of a keyword, such as a keyboard and a mouse, an effect of reducing the burden will be significant. It goes without saying that the present invention is applicable to a device provided with an input device facilitating input of a keyword.

Especially, since keyword candidates are displayed on the display section so that an operator can select a desired keyword from among them, the operator can visually check and select a keyword which satisfies his taste.

Furthermore, since a target image data to which a keyword has been added is stored in a storage medium, the keyword can be stored together with the target image data.

If a keyword is written in the header portion of a target image data when the keyword is added to the image data, it is possible to execute image retrieval with the use of the keyword when the recording medium is connected to a different image retrieval device for image retrieval.

If the keyword is written in a file different from a file for the target image data, image retrieval can be executed only by referring to the different file without necessity of referring to the image data file. Thereby, faster image retrieval can be expected.

If the keyword is embedded in the target image data, it is possible to execute image retrieval with the use of the keyword when the recording medium is connected to a different image retrieval device for image retrieval.

If the keyword is reflected on the filename of the target image data, the operator can determine the content of the image only by checking the filename.

Furthermore, according to this embodiment, it is possible to add or delete an image data for which a keyword is set to or from a search database, or change it, and accordingly, it is possible to reflect the taste of the operator on the search database.

Since the search database can also be stored in a recording medium, it is possible to easily update the search database even in the case of an image retrieval device without communication means.

### Second Embodiment

In the First Embodiment, a keyword of a similar image data is diverted. This embodiment enables selection of a keyword of an addition target image data from among keywords of image data to which keywords are already added. In addition to the keyword addition mode according to the First Embodiment, the image retrieval device 100 may be provided with this mode according to the Second Embodiment. In this case, a mode is selected from a menu to be displayed on the display section 104.

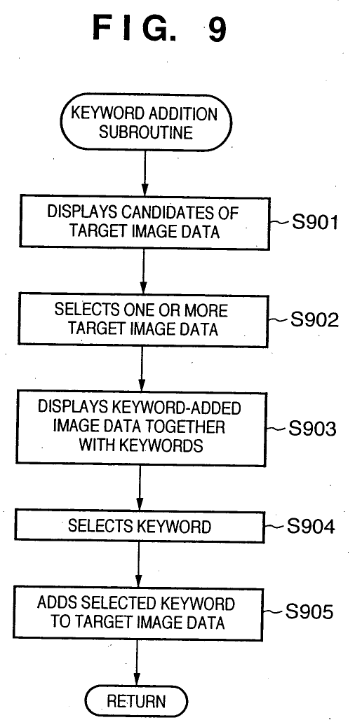

FIG. 9 shows an illustrative keyword addition process according to this embodiment. It is assumed that image data to which keywords have been added in advance (referred to as keyword-added image data) are stored in the storage medium of the storage section 105.

At step S901, the operation/retrieval section 102 reads addition target image data from the storage medium of the storage section 105, and displays them on the display section 104. The addition target image data are displayed, for example, in order of time with the latest imaging time is at the top.

At step S902, the operation/retrieval section 102 selects one or more target image data in response to a selection instruction from the operation section 103.

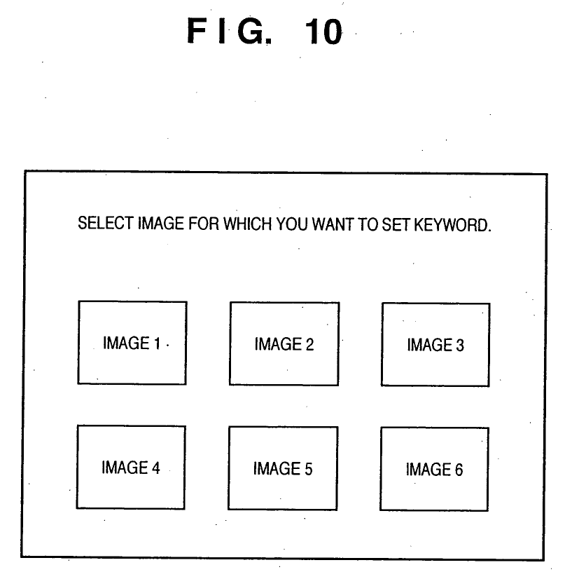

FIG. 10 shows an example of a screen for selecting an addition target image, according to this embodiment. An operator selects one or more target image data, to which he wants to add a keyword.

At step S903, the operation/retrieval section 102 reads keyword-added image data, to which keywords are already added, and their keywords from the storage medium of the storage section 105 and displays them on the display section 104.

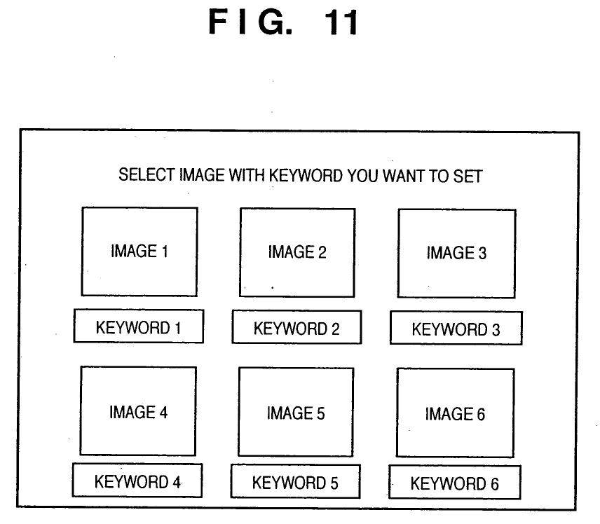

FIG. 11 shows an example of a screen display for selecting a keyword-added image data and its keyword, according to this embodiment. It will be understood that keywords are displayed together with keyword-added image data.

At step S904, the operation/retrieval section 102 selects a keyword-added image data or a keyword in response to a selection instruction from the operation section 103. For example, if the operator selects one or more image data on this screen, the keywords added to the image data are selected. A keyword may be directly selected from the operation section 103.

At step S905, the operation/retrieval section 102 adds the selected keyword to the target image data.

As described above, according to this embodiment, a keyword of an image data to which the keyword is already been added is diverted, and thereby a burden in inputting a keyword can be reduced. For example, when multiple image data with high similarity are acquired as in the case of continuous shooting or using an auto bracket function, it is easy, by adding a keyword to one of the image data, to add the keyword to the other image data.

### Other Embodiments

In the First Embodiment, the search database 107 is described as existing inside the image retrieval device 100. However, it may exist external to the image retrieval device 100. In this case, the operation/retrieval section 102 sends a retrieval request or receives a retrieval result to or from a database server via the external interface section 106. If the search database 107 is updated from a computer provided with an operation section with better operability than that of the image retrieval device 100, the update work will be easier. Furthermore, since the search database 107 can be shared by multiple image retrieval devices, keyword candidates may be more sufficient.

Various embodiments have been described above. The present invention may be applied to a system configured by multiple pieces of equipment or to a device configured by one piece of equipment.

The present invention is also achieved by supplying a software program for realizing each function of the above-described embodiments (a program corresponding to the flowchart in FIG. 4, 5, 8 or 9 in this embodiment) to a system or a device directly or remotely, and by a computer included in the system or the device reading and executing the supplied program code.

Thus, the program code which is to be installed in a computer to realize the functions and the processes of the present invention by the computer is also what realizes the present invention. That is, the computer program for realizing the above-described functions and processes itself is one aspect of the present invention.

In this case, the program may be in any form, such as an object code, a program to be executed by an interpreter and a script data to be provided to an OS, only if the functions of the program are provided.

As the recording medium for providing the program, there are, for example, a flexible disk, hard disk, optical disk, magneto-optical disk, MO, CD-ROM, CD-R, CD-RW, magnetic tape, non-volatile memory card, ROM, DVD (DVD-ROM, DVD-R) and the like.

As for the method of providing the program, it is possible to enable the program to be provided by connecting to a homepage on the Internet with the use of a browser of a client computer and downloading the computer program of the present invention itself or a compressed file including an automatic installation function from the homepage to a recording medium such as a hard disk. Provision of the program can be also realized by dividing the program code configuring the program of the present invention into multiple files and causing each file to be downloaded from different homepages. That is, in some cases, a WWW server for enabling multiple operators to download a program file for realizing the functions and processes of the present invention by a computer may be a configuration requirement of the present invention.

Provision of the program is also possible by distributing the program of the present invention encrypted and stored in a storage medium such as a CD-ROM to operators and enabling operators who have cleared predetermined conditions to download decryption key information from a homepage via the Internet and execute the decrypted program and install it in a computer with the use of the key information.

The functions of the above-described embodiments are realized by a computer reading and executing the program. In addition, the functions of the above-described embodiments can also be realized by the OS running on a computer performing a part or all of the actual processes in response to instructions of the program.

Furthermore, the function of the above-described embodiments are also realized by a CPU or the like provided for a function enhancement board inserted in a computer or a function enhancement unit connected to a computer performing a part or all of the actual processes based on instructions of the program, after the program being read from a recording medium and written in a memory provided for the feature expanded board or the feature expanded unit.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent Application No. 2004-173012 filed on Jun. 10, 2004, which is hereby incorporated by reference herein.

1. An image retrieval device comprising:
a storage medium for storing a target image data to which a keyword is to be added;
a retrieval unit for retrieving similar image data, which are similar to the target image data, from a database in which the similar image data and keywords corresponding to the similar image data are stored; and
an addition unit for reading the keywords corresponding to the similar image data retrieved from the database and adding the keywords to the target image data.

2. The image retrieval device according to claim 1, further comprising:
a display unit for displaying the keywords corresponding to the retrieved similar image data as addition candidates; and
a selection unit for selecting one or more of the displayed addition candidates; wherein
the addition unit adds the selected addition candidates as keywords of the target image data.

3. The image retrieval device according to claim 2, wherein
the addition unit comprises a writing control unit for writing the target image data with the keyword added thereto on the storage medium.

4. The image retrieval device according to claim 3, wherein
the addition unit includes at least one of a unit for writing the keyword in the header portion of the target image data, a unit for writing the keyword in a file different from the file of the target image data, a unit for embedding the keyword in the target image data or a unit for reflecting the keyword on the name of the file of the target image data.

5. The image retrieval device according to claim 1, wherein
the addition unit comprises a unit for adding the keyword added to the target image data to one or more other target image data generated related to the target image data.

6. The image retrieval device according to claim 1, further comprising a registration unit for registering the target image data with the keyword added thereto with the database.

7. The image retrieval device according to claim 1, further comprising a communication unit for sending a retrieval request to the database installed external to the image retrieval device and receiving a result of retrieval performed in response to the retrieval request.

8. The image retrieval device according to claim 1, wherein the database is stored in the storage medium.

9. An image retrieval method comprising the steps of:
reading a target image data to which a keyword is to be added, from a storage medium;
retrieving similar image data, which are similar to the target image data, from a database in which the similar image data and keywords corresponding to the similar image data are stored;
reading the keywords corresponding to the retrieved similar image data from the database; and
adding the read keywords to the target image data.

10. A computer readable storage medium which stores a computer program for causing a computer to be connected by or mounted with a storage medium which stores a target image data to which a keyword is to be added, to execute the steps of:
retrieving similar image data, which are similar to the target image data, from a database in which the similar image data and keywords corresponding to the similar image data are stored;
reading the keywords corresponding to the retrieved similar image data from the database; and
adding the read keywords to the target image data.

11. An image retrieval device comprising:
a storage medium for storing multiple image data;
a unit for reading one or more target image data to be added the same keyword among the multiple image data from the storage medium; and
a unit for
adding keywords of keyword-added image data, image data for which a keyword has already been added among the multiple image data, as keywords of the read target image data.

12. An image retrieval device comprising:
a storage medium for storing multiple image data;
a unit for reading one or more image data among the multiple image data stored in the storage medium;
a unit for displaying the read one or more image data;
a unit for specifying one or more target image data to be added the same keyword among the displayed image data;
a unit for reading keyword-added image data, for which a keyword has already been added among the multiple image data and the keywords from the storage medium;
a unit for displaying the read keyword-added image data and the keywords;
a unit for selecting a keyword to be added to the specified one or more target image data from the displayed keywords; and
a unit for adding the selected keyword to the one or more target image data.

13. An image retrieval method comprising the steps of:
reading one or more target image data to be added the same keyword, from a storage medium which stores multiple image data; and
adding keywords of keyword-added image data, image data for which a keyword has already been added among the multiple image data, as keywords of the read target image data.

14. An image retrieval method comprising the steps of:
reading one or more image data from a storage medium which stores multiple image data;
displaying the read one or more image data;
specifying one or more target image data to be added the same keyword among the displayed image data;
reading keyword-added image data, image data for which a keyword has already been added among the multiple image data and the keywords from the storage medium;
displaying the read keyword-added image data and the keywords;
selecting a keyword to be added to the specified one or more target image data from the displayed keywords; and
adding the selected keyword to the one or more target image data.

15. A computer readable storage medium which stores a computer program for causing a computer to be connected by or mounted with a storage medium which stores multiple image data to execute the steps of:
reading one or more target image data to be added the same keyword from the storage medium; and
adding keywords of keyword-added image data, image data for which a keyword has already been added among the multiple image data, as keywords of the read target image data.

16. A computer readable storage medium which stores a computer program for causing a computer to be connected by or mounted with a storage medium which stores multiple image data to execute the steps of:
reading one or more of the image data from the storage medium;
displaying the read one or more image data;
specifying one or more target image data to be added the same keyword among the displayed image data;
reading keyword-added image data, image data for which a keyword has already been added among the multiple image data and the keywords from the storage medium;
displaying the read keyword-added image data and the keywords;
selecting a keyword to be added to the specified one or more target image data from the displayed keywords; and
adding the selected keyword to the one or more target image data.
